(19) United States
(12) Patent Application Publication
(10) Pub. No.: US 2019/0127599 A1
(43) Pub. Date: May 2, 2019

(54) DISPERSION OF IR ABSORPTION PARTICLES, INKJET INK, AND METHOD OF 3D PRINTING

(71) Applicant: Industrial Technology Research Institute, Hsinchu (TW)

(72) Inventors: Jer-Young CHEN, Hsinchu City (TW); Yi-Tsung PAN, Tainan City (TW); Shinn-Jen CHANG, Hsinchu City (TW); Cha-Wen CHANG, Zhongpu Township (TW); Feng-Meei WU, Hsinchu City (TW); Chen-Yu CHEN, New Taipei City (TW); Ping-Chen CHEN, Zhubei City (TW); Ching-Sung CHEN, Xiushui Township (TW)

(73) Assignee: Industrial Technology Research Institute, Hsinchu (TW)

(21) Appl. No.: 16/175,171

(22) Filed: Oct. 30, 2018

Related U.S. Application Data
(60) Provisional application No. 62/580,066, filed on Nov. 1, 2017.

(30) Foreign Application Priority Data
Aug. 6, 2018 (TW) 107127273

(51) Int. Cl. C09D 11/107; C09D 11/38; C09D 11/03; C08F 293/00; B33Y 10/00; B33Y 70/00; B29C 64/165

(52) U.S. Cl. CPC C09D 11/107; C09D 11/38; C09D 11/03; C08F 293/005; B29K 2105/0005; B33Y 70/00; B29C 64/165; C08F 2438/01; B33Y 10/00

(57) ABSTRACT

A dispersion of IR absorption particles is provided, which includes 100 parts by weight of IR absorption particles, 5 to 30 parts by weight of diblock copolymer, and 200 to 910 parts by weight of water, wherein the diblock copolymer includes (a) first block of

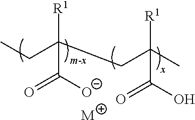

and (b) second block of

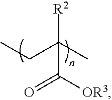

wherein (a) first block is chemically bonded to (b) second block; R¹ is H or CH₃; R² is H or CH₃; R³ is

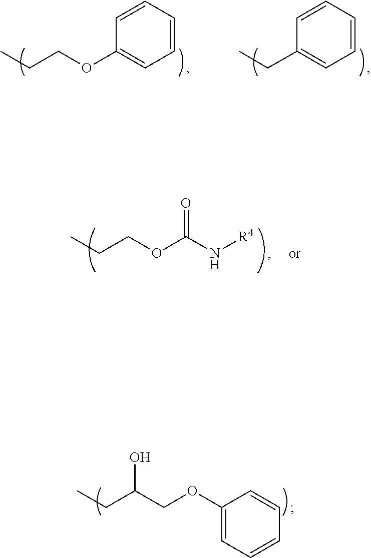

R⁴ is C₁₋₁₀ alkyl group; M^{⊕} is Na⁺, NH₄⁺, or NH(C₂H₄OH)₃⁺; m=10-20; n=2-20; and x=0-4.

### CROSS REFERENCE TO RELATED APPLICATIONS

This application claims the benefit of U.S. Provisional Application No. 62/580,066, filed on Nov. 1, 2017, the entirety of which is incorporated by reference herein.

The application is based on, and claims priority from, Taiwan Application Serial Number 107127273, filed on Aug. 6, 2018, the disclosure of which is hereby incorporated by reference herein in its entirety.

### TECHNICAL FIELD

The technical field relates to a dispersion, and in particular it relates to its applications in inkjet ink and 3D printing.

### BACKGROUND

3D printing and fast-shaping technology utilizes an adhesive material such as a metal or plastic powder to construct an object by stack-by-stack accumulation, which is a simple, rapid, and digital-additive process without the need for a mold. The 3D printing process may be used to manufacture a product with a specific configuration. The 3D printing process is not yet widespread, and the key issue is the lack of various colorants in the final product.

Accordingly, a novel inkjet ink used in 3D printing to form colorful products is called for.

### SUMMARY

One embodiment of the disclosure provides a dispersion of IR absorption particles, including 100 parts by weight of IR absorption particles, 5 to 30 parts by weight of diblock copolymer, and 200 to 910 parts by weight of water. The diblock copolymer includes (a) first block of

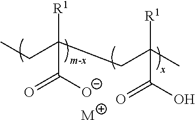

and (b) second block of

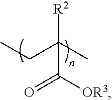

wherein (a) first block is chemically bonded to (b) second block; R¹ is H or CH₃; R² is H or CH₃; R³ is

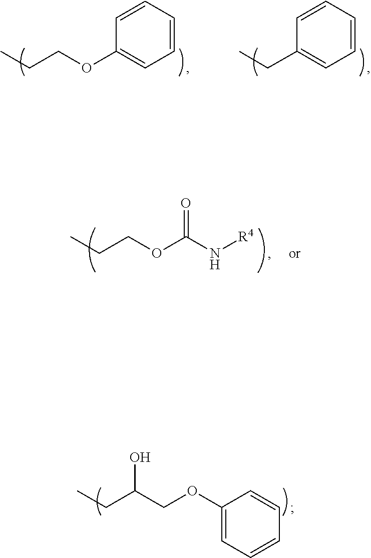

R⁴ is C₁₋₁₀ alkyl group; M^{⊕} is Na⁺, NH₄⁺, or NH(C₂H₄OH)₃⁺; m=10-20; n=2-20; and x=0-4.

One embodiment of the disclosure provides an inkjet ink, including a dispersion of IR absorption particles, 30 to 1000 parts by weight of polar solvent, and 1 to 10 parts by weight of additive. The dispersion of IR absorption particles includes 100 parts by weight of IR absorption particles, 5 to 30 parts by weight of diblock copolymer, and 200 to 910 parts by weight of water. The diblock copolymer includes (a) first block of

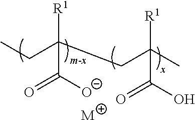

and (b) second block of

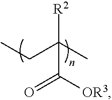

wherein (a) first block is chemically bonded to (b) second block; R¹ is H or CH₃; R² is H or CH₃; R³ is

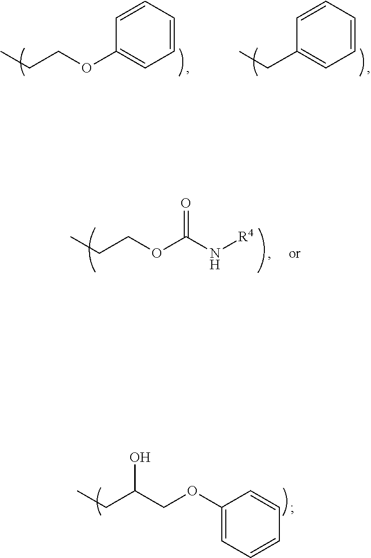

R⁴ is C₁₋₁₀ alkyl group; M^{⊕} is Na⁺, NH₄⁺, or NH(C₂H₄OH)₃⁺; m=10-20; n=2-20; and x=0-4.

One embodiment of the disclosure provides a method of 3D printing, including: providing a layer, wherein the layer includes polymer powders; applying an inkjet ink to the layer for forming a pattern; applying IR to the layer for fusing and shaping the pattern; and removing the polymer powders which are out of the pattern. The inkjet ink includes a dispersion of IR absorption particles, 30 to 1000 parts by weight of polar solvent, and 1 to 10 parts by weight of additive. The dispersion of IR absorption particles includes 100 parts by weight of IR absorption particles, 5 to 30 parts by weight of diblock copolymer, and 200 to 910 parts by weight of water. The diblock copolymer includes (a) first block of

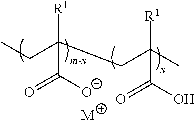

and (b) second block of

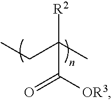

wherein (a) first block is chemically bonded to (b) second block; R¹ is H or CH₃; R² is H or CH₃; R³ is

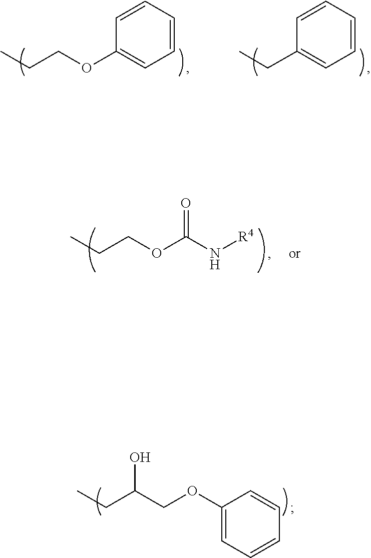

R⁴ is C₁₋₁₀ alkyl group; M^{⊕} is Na⁺, NH₄⁺, or NH(C₂H₄OH)₃⁺; m=10-20; n=2-20; and x=0-4.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a dispersion of IR absorption particles, which includes 100 parts by weight of IR absorption particles, 5 to 30 parts by weight of diblock copolymer, and 200 to 910 parts by weight of water. If the amount of diblock copolymer is too low, the IR absorption particles cannot be efficiently dispersed. If the amount of diblock copolymer is too high, this may increase the viscosity of the dispersion and influence the viscosity of ink utilizing the dispersion. As such, it is difficult to inkjet the ink when the viscosity is too high. Too little water will increase the chance of collision and friction between the IR absorption particles in water, and cause the viscosity of the dispersion to be too high, or even cause aggregation and precipitation. Too much water results in an increase in the amount of dispersion for preparing ink, and a narrowing of the amount range of the polar solvent and additive. In one embodiment, the IR absorption particles have a diameter of 10 nm to 500 nm. For example, the IR absorption particles can be added to a mixture liquid of diblock copolymer and water to be stirred and dispersed, thereby obtaining the dispersion of the IR absorption particles.

In one embodiment, the IR absorption particles can be antimony tin oxide, tungsten oxide, MₐWO_{3-b}A_{b}, MₐWO_{3-b}, or a combination thereof, wherein M is alkali metal such as lithium, sodium, potassium, rubidium, cesium, or a combination thereof; A is halogen element such as fluorine, chlorine, bromine, iodine, or a combination thereof; 0<a≤1; and 0≤b≤0.8. The IR absorption particles MₐWO_{3-b}A_{b} are tungsten oxide material co-doped by alkali metal cation and halogen anion, which may absorb the IR with a wavelength of 700 nm to 2400 nm.

In one embodiment, method of forming the IR absorption particles MₐWO_{3-b}A_{b} is provided. Tungsten oxide is synthesized in a liquid system, and alkali metal salt and halogen salt in suitable ratios are added to the liquid system to form a mixture. After removing the solvent of the liquid system, the mixture is heated at a temperature of 300° C. to 800° C. to perform a chemical reduction reaction in a hydrogen environment to form the IR absorption particles composed of MₐWO_{3-b}A_{b}.

Alternatively, the IR absorption particles MₐWO_{3-b}A_{b} are formed in a solid system. First, tungsten oxide or a precursor or a salt for forming tungsten oxide is provided in the solid system. Alkali metal salt and halogen salt in suitable ratios are then added into the solid system to form a mixture. Next, the mixture is heated at a temperature of 300° C. to 800° C. to perform a chemical reduction reaction in a hydrogen environment to form the IR absorption particles composed of MₐWO_{3-b}A_{b}.

Alternatively, the halogen element of MₐWO_{3-b}A_{b} can be provided by the precursor for forming tungsten oxide and/or the alkali metal salt.

In one embodiment, method of forming the IR absorption particles MₐWO_{3-b} is provided. Tungsten oxide is synthesized in a liquid system, and alkali metal salt in a suitable ratio is added to the liquid system to form a mixture. After removing the solvent of the liquid system, the mixture is heated at a temperature of 300° C. to 800° C. to perform a chemical reduction reaction in a hydrogen environment to form the IR absorption particles composed of MₐWO_{3-b}.

Alternatively, the IR absorption particles MₐWO_{3-b} are formed in a solid system. First, tungsten oxide or a precursor or a salt for forming tungsten oxide is provided in the solid system. Alkali metal salt in a suitable ratio is then added into the solid system to form a mixture. Next, the mixture is heated at a temperature of 300° C. to 800° C. to perform a chemical reduction reaction in a hydrogen environment to form the IR absorption particles composed of MₐWO_{3-b}.

The alkali metal salt can be represented as MₚN, wherein M is an alkali metal element such as lithium, sodium, potassium, rubidium, cesium, or a combination thereof, N is an anion or an anion group with negative valence, and 1≤p≤12. The alkali metal salt MₚN can be alkali metal carbonate, alkali metal hydrocarbonate, alkali metal nitrate, alkali metal nitrite, alkali metal hydroxide, alkali metal halide, alkali metal sulfate, alkali metal sulfite, another alkali metal-containing salt, or a combination thereof.

The halogen salt can be represented by the formula PA_{q}, wherein A is halogen element including fluorine (F), chlorine (Cl), bromine (Br) or iodine (I), P is a cation or a cation group with positive valence, and 1≤q≤12. The halogen salt can be ammonium halide, alkylammonium salt, halocarbon, hydrogen halide, tungsten halide, benzene halide, halogenated aromatic compound, alkyl halide, another halogen-containing salt, or a combination thereof.

The precursor of forming tungsten oxide can be ammonium metatungstate, ammonium orthotungstate, ammonium paratungstate, alkali metal tungstate, tungstic acid, tungsten silicide, tungsten sulfide, tungsten oxychloride, tungsten alkoxide, tungsten hexachloride, tungsten tetrachloride, tungsten bromide, tungsten fluoride, tungsten carbide, tungsten oxycarbide, another tungsten-containing salt, or a combination thereof.

In one embodiment, the diblock copolymer serves as a dispersant for the IR absorption particles, which includes (a) first block of

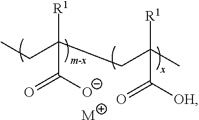

and (b) second block of

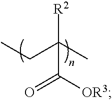

(a) first block is chemically bonded to (b) second block; R¹ is H or CH₃; R² is H or CH₃; R³ is

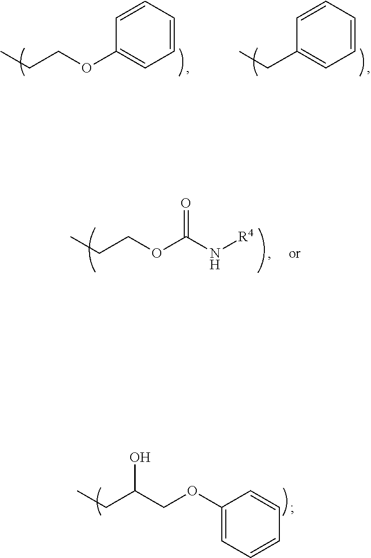

R⁴ is C₁₋₁₀ alkyl group; M^{⊕} is Na⁺, NH₄⁺, or NH(C₂H₄OH)₃⁺; m=10-20; n=2-20; and x=0-4. An m value that is too low results in the ionic ratio in the copolymer being so low that the dispersant cannot be dissolved in water. If the m value is too high, the dispersant amount for dispersing will be too much. If the n value is too low, the anchoring segment cannot be efficiently adsorbed onto the powder. If the n value is too high, the anchoring segment will easily adsorb onto another powder and aggregate the powders. If the x value is too high, the copolymer will include insufficient carboxylate group. As such, the solvation segment cannot be completely dispersed in water, which cannot provide an effective steric effect. In one embodiment, m and n have a ratio of 7:1 to 1:2. If the m/n ratio is too low, the dispersant cannot be easily dissolved in water. If the m/n ratio is too high, the dispersant amount for dispersing will be too much. The copolymer may have weight average molecular weight (Mw) of 2000 to 8000, number average molecular weight (Mn) of 1000 to 5000, and poly dispersity index (PDI) of less than 1.8 and greater than 1. If the molecular weight of the copolymer is too high, the solvation segment that is too long will provide an overly high steric effect result in dispersing a lower amount of pigment, or the anchoring segment that is too long may easily cause the bridging phenomenon to aggregate and precipitate the powders (e.g. lowering the dispersing effect, and improper to disperse the nano-scaled particles). If the molecular weight of the copolymer is too low, the solvation segment cannot provide a sufficient steric effect, or the anchoring segment cannot efficiently adsorb onto the powder (e.g. lowering the dispersing effect). When a copolymer with too high a PDI is applied to disperse the powders, the dispersed powders may have a distribution of the particle diameter that is too wide. In one embodiment, (a) first block is

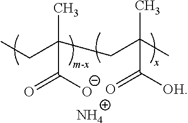

In one embodiment, (a) first block is

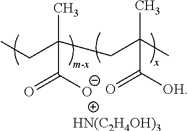

In one embodiment, (b) second block is

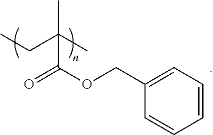

In one embodiment, (b) second block is

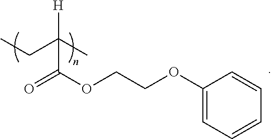

In one embodiment, (b) second block is

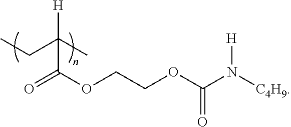

In one embodiment, (b) second block is

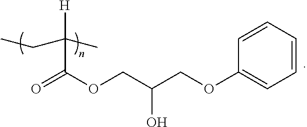

In one embodiment, the diblock copolymer can be synthesized as described below. Note that the diblock copolymer is not limited to being synthesized by the following steps, and one skilled in the art may select a suitable synthesis strategy to form the diblock copolymer on the basis of the disclosure.

First, copper(I) bromide (CuBr), copper(II) bromide (CuBr₂) and N,N,N′,N′,N″-pentamethyl diethylenetriamine (PMDETA) are dissolved in tetrahydrofuran (THF). p-Toluenesulfonyl chloride (TsCl) and acrylate are added into the above solution, and then heated to perform atom transfer radical polymerization (ATRP) as shown below:

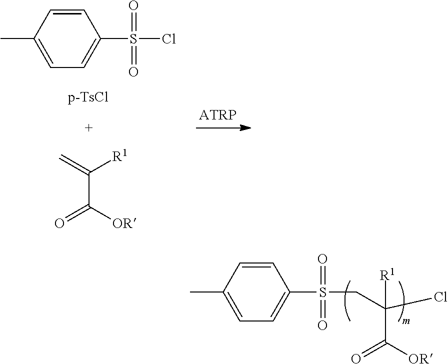

After the acrylate monomer is completely reacted, another acrylate with R³ is then added to the above reaction to continue the ATRP reaction as shown below:

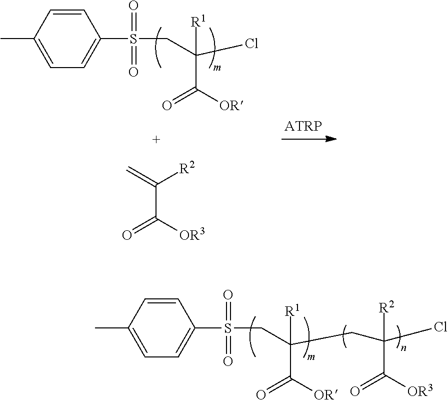

It should be understood that the reaction order of the two types of acrylates can be reversed and not limited to the described order. Note that whatever reaction order is selected, it is necessary to confirm that the reactants are free of the first type of acrylate before adding the second type of acrylate. This is because the residue of the first type of acrylate may result in a random copolymer rather than the diblock copolymer.

Acid is then added to convert R′ group to H, and alkaline is then added to neutralize the copolymer, for example, as shown below:

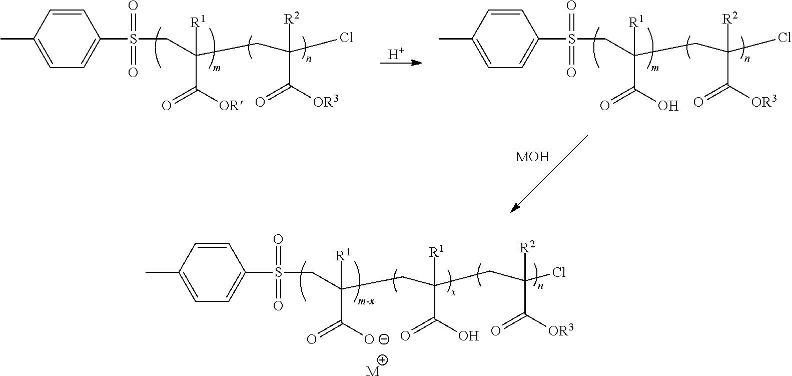

In one embodiment, the neutralization step may adjust the pH value of the solution to be alkaline (e.g. pH=8 to 10) for ensuring that all the acid converts to salt (e.g. x=0). Because the two types of acrylates are reacted sequentially rather than simultaneously, the copolymer will be a block copolymer rather than a random copolymer. As proven by experimentation, even if the same reactants (e.g. acrylates) are selected to perform the ATRP reaction, the diblock copolymer of the disclosure has a better dispersing effect than the random copolymer in dispersion.

In one embodiment, the inkjet ink includes the described dispersion of the IR absorption particles, 30 to 1000 parts by weight of polar solvent (on the basis of 100 parts by weight of the IR absorption particles in the dispersion of IR absorption particles), and 1 to 10 parts by weight of additive (on the basis of 100 parts by weight of the IR absorption particles in the dispersion of IR absorption particles). An insufficient amount of polar solvent may lower the drying rate of the ink. An excessive amount of polar solvent may result in the drying rate of the ink being too fast. An insufficient amount of additive may cause the ink to have too much surface tension, such that the leveling and wetting properties of the substrate and the nozzle of the 3D printer are reduced. Too much additive may cause the viscosity of the ink to be too high, thereby making it difficult to inkjet the ink. In one embodiment, the dispersion of the IR absorption particles, the polar solvent, and the additive can be mixed and stirred to form the inkjet ink. Note that the dispersion of the IR absorption particles should be formed, and then mixed with the polar solvent and the additive to form the inkjet ink. If the IR absorption particles, the dispersant, water, the polar solvent, and the additive are mixed directly, the dispersing effect of the IR absorption particles may be poor.

In one embodiment, the polar solvent can be water, N-methyl-2-pyrrolidone, 2-pyrrolidone, diethylene glycol, glycerin, hexylene glycol and propylene glycol, butylene glycol, pentylene glycol, hexylene glycol, polyethylene glycol, ethylene glycol monobutyl ether, or a combination thereof. In one embodiment, the additive can be aqueous copolymer, polyether modified polydimethylsiloxane, or a combination thereof.

Note that the inkjet ink has a low absorbance (absorbance≤50%; transmittance≥15%) in visible light region (400 nm to 700 nm). In other words, the inkjet has high transparency, and further pigments can be added for fine-tuning its color.

In one embodiment, the inkjet ink further includes a pigment dispersion. The pigment dispersion includes 2 to 10 parts by weight of water (on the basis of 100 parts weight of the IR absorption particles in the dispersion of the IR absorption particles), 0.1 to 2.0 parts by weight of pigment (on the basis of 100 parts weight of the IR absorption particles in the dispersion of the IR absorption particles), and 0.1 to 0.6 parts by weight of dispersant (on the basis of 100 parts weight of the IR absorption particles in the dispersion of the IR absorption particles). Too little water or too much pigment can make the pigment difficult to disperse efficiently. Too much water or too little pigment cannot achieve sufficient chromaticity for the pigment dispersion. Too little dispersant can make the pigment difficult to disperse efficiently. Too much dispersant will increase the cost and make the pigment impossible to disperse further. The dispersant of the pigment dispersion can be similar to the diblock copolymer of the dispersion of the IR absorption particles, such that the pigment dispersion can be compatible with the other components of the inkjet ink (especially the diblock copolymer of the dispersion of the IR absorption particles). The inkjet ink including the pigment dispersion may have the color of the pigment, which is beneficial to form a colorful 3D printing product. In this embodiment, the dispersion of the IR absorption particles, the pigment dispersion, the polar solvent, and the additive can be mixed and stirred to obtain the colorful inkjet ink. Note that the dispersion of the IR absorption particles and the pigment dispersion should be prepared respectively, and then mixed with the polar solvent and additive to form a colorful inkjet ink. If the IR absorption particles, the diblock polymer, the water, the polar solvent, the additive, the pigment, and the dispersant are mixed directly, the dispersing effect of the IR absorption particles and the pigment is poor.

In one embodiment, the pigment can be blue pigment (e.g. HELIOGEN BLUE L 6700 F, commercially available from BASF), yellow pigment (e.g. Paliotol® Yellow D 1080 J, commercially available from BASF), red pigment (e.g. Irgazin® Red L 3630, commercially available from BASF), or a combination thereof.

In one embodiment, the method of 3D printing includes providing a layer. The layer includes polymer powders, such as polyamide, thermoplastic polyurethane elastomer, polyurethane, polyethylene, polyvinylidene fluoride, polyoxymethylene, polypropylene, polystyrene, polylactic acid, polycarbonate, ABS resin (acrylonitrile-butadiene-styrene copolymer), or a combination thereof. The polymer powder may have a diameter of 1 μm to 400 μm. The polymer powder that is too small has a larger specific surface area and a higher the molecular attraction between the polymer powders. As such, the flowability of the polymer powder is lowered, making it unsuitable for use in a 3D printer. If the polymer powder is too large, voids may remain between the polymer powders after 3D printing, and the voids may negatively influence the bending strength of the shaped product. The layer of the polymers powder may have a thickness of 0.02 mm to 0.80 mm. A layer of the polymer powders that is too thin results in an overly long printing period. If a layer of the polymer powders is too thick, the IR heat cannot efficiently transfer to the polymer powders at bottom of the layer, which is unbeneficial to fuse the polymer powders.

Subsequently, the method of 3D printing applies the inkjet ink to the layer to form a pattern. In one embodiment, the method of applying the inkjet ink can be inkjetting or another suitable method. An IR is then applied to the layer to fuse and shape the polymer powder in the pattern. The IR absorption particles in the inkjet pattern (containing the inkjet ink and the polymer powder) may absorb the IR to increase the temperature, such that the polymer powders around the IR absorption particles is fused as a block body. The polymer powders out of the inkjet pattern (only containing the polymer powder) have a low IR absorption effect and are difficult to increase the temperature to be fused as a block body. Thereafter, the polymer powders out of the pattern are removed to form a layered pattern. The steps of forming a layer of polymer powder, applying the inkjet ink to the layer to form a pattern, and applying IR to the layer for fusing and shaping the polymer powders of the pattern can be repeated several times. The polymer powders out of the pattern can be removed to form a laminated 3D pattern. In one embodiment, the method of removing the polymer powders which are out of the pattern can be rinsing the product with a fluid. The fluid can be in a gaseous state or a liquid state, and the polymer is not dissolved by the fluid. If the inkjet ink includes a pigment dispersion to add color, the appearance of the product will be colorful. Note that the layered region applied by the inkjet ink (fusing region) and the layered region without the inkjet ink (non-fusing region) have a temperature difference of at least 68° C. (even near 70° C.) after being exposed to IR. Therefore, the polymer powders in the fusing region are easily fused as block body.

In one embodiment, the IR has a wavelength of 760 nm to 3500 nm for corresponding to the maximum absorption wavelength of the IR absorption particles. The IR power can be 100 W to 3000 W. If IR power is too low, it may lengthen the fusing period. If the IR power is too high, it may partially fuse the polymer powders without the inkjet ink (out of the pattern), which may degrade product quality. The IR fusing period can be from 5 seconds to 15 seconds. An IR fusing period that is too short may not efficiently fuse the polymer powders with the inkjet ink in the pattern. An IR fusing period that is too long may partially fuse the polymer powders without the inkjet ink (out of the pattern), which may degrade product quality.

The inventive concept may be embodied in various forms without being limited to the exemplary embodiments set forth herein. Descriptions of well-known parts are omitted for clarity, and like reference numerals refer to like elements throughout.

### EXAMPLES

### Preparation Example 1 (Preparation of Diblock Copolymer DBDP05)

Four-neck bottle A was vacuumed and nitrogen was introduced, and 12.18 g of N,N,N′,N′,N″-pentamethyl diethylenetriamine (PMDETA, 70.32 mmole) and 65 mL of THF were then added into four-neck bottle A. The THF solution was bubbled with nitrogen to be degassed for 30 minutes, and 10.08 g of CuBr (70.32 mmole) was then added into the THF solution and stirred for 20 minutes. 3.14 g of CuBr₂ (14.06 mmole) was then added to the THF solution and stirred for 10 minutes.

Two-neck bottle B was vacuumed and nitrogen was introduced, and 100.00 g of tBMA (703.23 mmole), 13.40 g of p-TsCl (70.32 mmole), and 65 mL of THF were then added into two-neck bottle B. The THF solution was bubbled with nitrogen to be degassed for 30 minutes. This solution in two-neck bottle B was then added to the solution in four-neck bottle A to be heated to 40° C. and reacted at 40° C. under nitrogen for 22 hours for forming PtBMA. The polymerization mechanism is ATRP. The reaction is shown below:

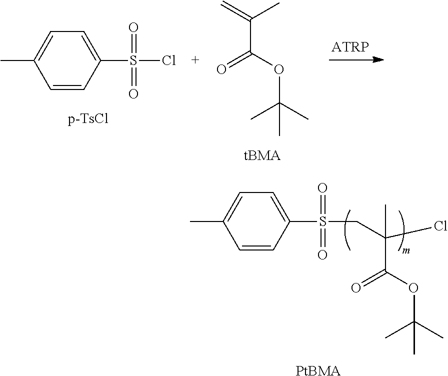

Two-neck bottle C was vacuumed and nitrogen was introduced, 74.35 g of BzMA (421.94 mmole) was then added into two-neck bottle C. BzMA was bubbled with nitrogen to be degassed for 30 minutes. The degassed BzMA in two-neck bottle C was then added to PtBMA in four-neck bottle A to be heated to 40° C. and reacted at 40° C. under nitrogen for 24 hours for forming diblock copolymer PtBMA-b-PBzMA. It should be understood that the monomers tBMA and BzMA were reacted sequentially rather than simultaneously, so the copolymer was a block copolymer rather than a random copolymer. The polymerization mechanism is ATRP.

The reaction was then cooled, and the crude solution was then filtered by neutral alumina column to collect filtrate. The filtrate was precipitated by n-hexane to collect white solid PtBMA-b-PBzMA (164.8 g). The product had Mw of 5600, Mn of 4700, and PDI of 1.3.

324.0 g of PtBMA-b-PBzMA (68.51 mmole) and 600 mL of dioxane were mixed and stirred under nitrogen. 29.5 mL of hydrochloric acid (342.57 mmole) was added into the mixture liquid, and then heated to 85° C. and reacted at 85° C. for 18 hours. The reaction was cooled and then condensed to remove solvent thereof. The crude was dissolved by THF to be flowable and low viscosity, and then filtered to remove the insoluble. The filtrated was added into n-hexane to be re-precipitated, and then filtered to collect the filtered cake. The filtered cake was dried to obtain white solid PMAA-b-PBzMA. PMAA-b-PBzMA had Mw of 3800, Mn of 2500, and PDI of 1.5.

100.0 g of PMAA-b-PBzMA powder was stirred and dispersed in 120 mL of de-ionized water, and triethanolamine solution was added into the dispersion to be heated to 70° C. and reacted at 70° C. for 5 hours. After the solid in the reaction was completely dissolved, the pH value of the solution was adjusted to at least 8 by triethanolamine, thereby obtaining diblock copolymer DBDP05. The reaction is shown below:

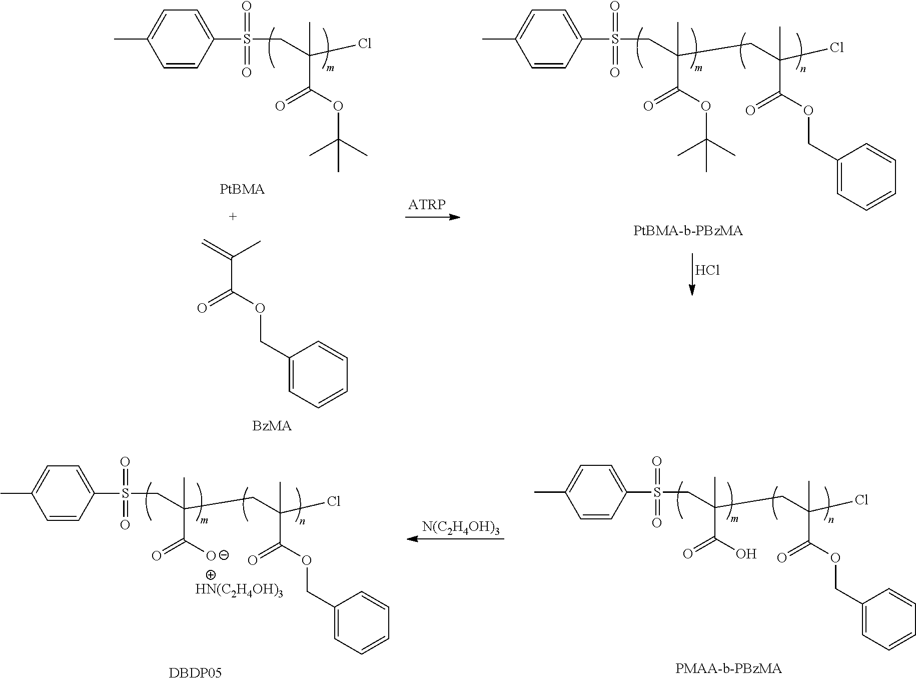

### Preparation Example 2 (Preparation of Diblock Copolymer DBDP06)

Four-neck bottle A was vacuumed and nitrogen was introduced, and 12.18 g of PMDETA (70.32 mmole) and 65 mL of THF were then added into four-neck bottle A. The THF solution was bubbled with nitrogen to be degassed for 30 minutes, and 10.08 g of CuBr (70.32 mmole) was then added into the THF solution and stirred for 20 minutes. 3.14 g of CuBr₂ (14.06 mmole) was then added to the THF solution and stirred for 10 minutes.

Two-neck bottle B was vacuumed and nitrogen was introduced, and 100.00 g of tBMA (703.23 mmole), 13.40 g of p-TsCl (70.32 mmole), and 65 mL of THF were then added into two-neck bottle B. The THF solution was bubbled with nitrogen to be degassed for 30 minutes. This solution in two-neck bottle B was then added to the solution in four-neck bottle A to be heated to 40° C. and reacted at 40° C. under nitrogen for 7 hours for forming PtBMA. The polymerization mechanism is ATRP. The reaction is shown below:

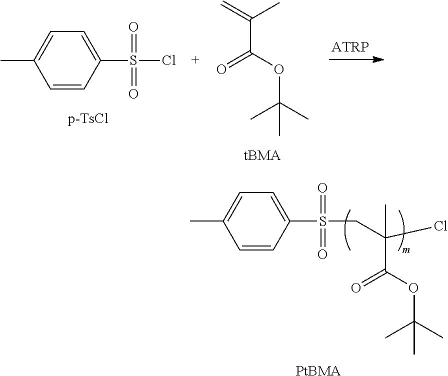

Two-neck bottle C was vacuumed and nitrogen was introduced, 74.35 g of BzMA (421.94 mmole) was then added into two-neck bottle C. BzMA was bubbled with nitrogen to be degassed for 30 minutes. The degassed BzMA in two-neck bottle C was then added to PtBMA in four-neck bottle A to be heated to 40° C. and reacted at 40° C. under nitrogen for 18 hours for forming diblock copolymer PtBMA-b-PBzMA. It should be understood that the monomers tBMA and BzMA were reacted sequentially rather than simultaneously, so the copolymer was a block copolymer rather than a random copolymer. The polymerization mechanism is ATRP.

The reaction was then cooled, and the crude solution was then filtered by neutral alumina column to collect filtrate. The filtrate was precipitated by n-hexane to collect white solid PtBMA-b-PBzMA. The product had Mw of 4200, Mn of 2800, and PDI of 1.5.

143.3 g of PtBMA-b-PBzMA (71.86 mmole) and 290 mL of dioxane were mixed and stirred under nitrogen. 30.9 mL of hydrochloric acid (359.33 mmole) was added into the mixture liquid, and then heated to 85° C. and reacted at 85° C. for 18 hours. The reaction was cooled and then condensed to remove solvent thereof. The crude was dissolved by THF to be flowable and low viscosity, and then filtered to remove the insoluble. The filtrated was added into n-hexane to be re-precipitated, and then filtered to collect the filtered cake. The filtered cake was dried to obtain white solid PMAA-b-PBzMA. PMAA-b-PBzMA had Mw of 2400, Mn of 1600, and PDI of 1.5.

60.0 g of PMAA-b-PBzMA powder was stirred and dispersed in 17.7 mL of de-ionized water, and 28.0 g of triethanolamine solution was added into the dispersion to be heated to 70° C. and reacted at 70° C. for 5 hours. After the solid in the reaction was completely dissolved, the pH value of the solution was adjusted to at least 8 by triethanolamine, thereby obtaining diblock copolymer DBDP06. The reaction is shown below:

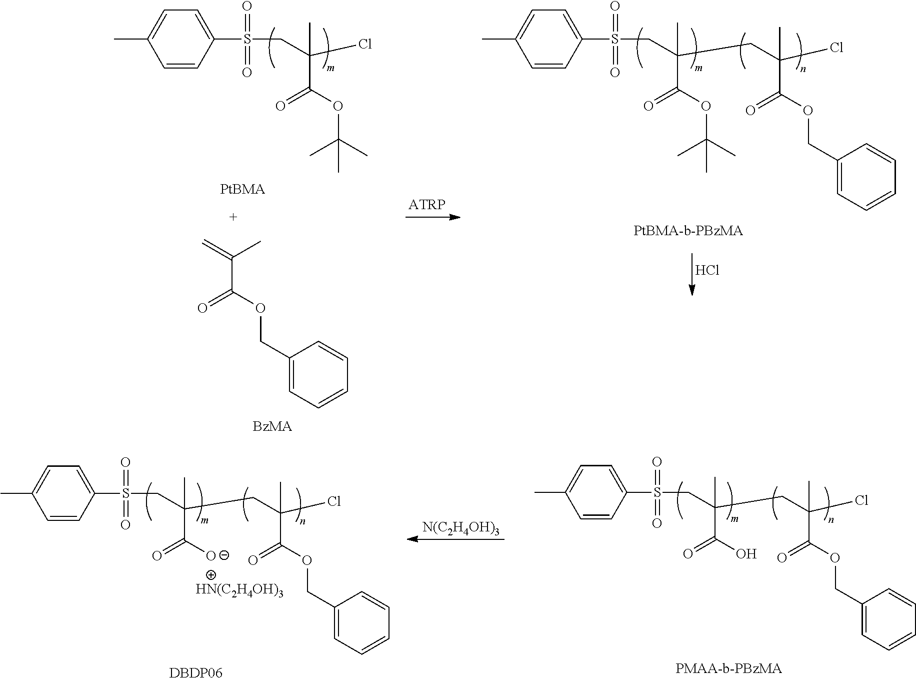

### Preparation Example 3 (Preparation of IR Absorption Particles)

10 g of ammonium metatungstate (commercially available from SHOWA) was added to water to prepare 30 wt % aqueous solution. 0.07 g of ammonium chloride (commercially available from SHOWA) was added to the aqueous solution of ammonium metatungstate to be evenly stirred to obtain a transparent solution. 2.2 g of cesium carbonate (commercially available from Alfa Aesar) was added to water to prepare 50 wt % aqueous solution. Subsequently, the aqueous solution of cesium carbonate was slowly and dropwise added into the transparent solution containing ammonium metatungstate and ammonium chloride to be mixed and stirred to obtain a transparent mixture liquid. The transparent mixture liquid was heated to 145° C. to remove water thereof for obtaining powder. The powder was heated at 550° C. under a chemical reduction environment (10 vol % H₂) for 20 minutes to form IR absorption particles Cs_{0.33}WO_{2.97}Cl_{0.03}.

### Preparation Example 4 (Preparation of IR Absorption Particles)

10 g of ammonium metatungstate (commercially available from SHOWA) was added to water to prepare 30 wt % aqueous solution. 2.2 g of cesium carbonate (commercially available from Alfa Aesar) was added to water to prepare 50 wt % aqueous solution. Subsequently, the aqueous solution of cesium carbonate was slowly and dropwise added into the transparent solution containing ammonium metatungstate to be mixed and stirred to obtain a transparent mixture liquid. The transparent mixture liquid was heated to 145° C. to remove water thereof for obtaining powder. The powder was heated at 550° C. under a chemical reduction environment (10 vol % H₂) for 20 minutes to form IR absorption particles Cs_{0.33}WO₃.

### Comparative Example 1

26.7 parts by weight of the IR absorption particles Cs_{0.33}WO_{2.97}Cl_{0.03} prepared by Preparation Example 3 and 2.67 parts by weight of dispersant BYK190 (commercially available from BYK) were added into 70.63 parts by weight of water, and continuously stirred at room temperature for 1 hour. Subsequently, 300 g of zirconium balls (diameter of 0.2 mm) were added into the dispersion to further disperse by ball-milling (2000 rpm) at 20° C. for 3 hours. The zirconium balls were then removed by filtering, and the dispersion was sampled to measure the diameter of the IR absorption particles thereof, as shown in Table 1.

### Comparative Example 2

12 parts by weight of the IR absorption particles Cs_{0.33}WO_{2.97}Cl_{0.03} prepared by Preparation Example 3 and 1.2 parts by weight of dispersant BYK190 (commercially available from BYK) were added into 86.8 parts by weight of water, and continuously stirred at room temperature for 1 hour. Subsequently, 300 g of zirconium balls (diameter of 0.2 mm) were added into the dispersion to further disperse by ball-milling (2000 rpm) at 20° C. for 3 hours. The zirconium balls were then removed by filtering, and the dispersion was sampled to measure the diameter of the IR absorption particles thereof, as shown in Table 1.

### Comparative Example 3

17.4 parts by weight of the IR absorption particles Cs_{0.33}WO_{2.97}Cl_{0.03} prepared by Preparation Example 3 and 1.74 parts by weight of dispersant BYK190 (commercially available from BYK) were added into 80.86 parts by weight of water, and continuously stirred at room temperature for 1 hour. Subsequently, 100 g of zirconium balls (diameter of 0.2 mm) were added into the dispersion to further disperse by ball-milling (2000 rpm) at 20° C. for 3 hours. The zirconium balls were then removed by filtering, and the dispersion was sampled to measure the diameter of the IR absorption particles thereof, as shown in Table 1.

### Example 1

20 parts by weight of the IR absorption particles Cs_{0.33}WO_{2.97}Cl_{0.03} prepared by Preparation Example 3 and 2 parts by weight of diblock copolymer DBDP05 prepared by Preparation Example 1 were added into 78 parts by weight of water, and continuously stirred at room temperature for 1 hour. Subsequently, 350 g of zirconium balls (diameter of 0.2 mm) were added into the dispersion to further disperse by ball-milling (2700 rpm) at 20° C. for 4 hours. The zirconium balls were then removed by filtering, and the dispersion was sampled to measure the diameter of the IR absorption particles thereof, as shown in Table 1.

### Example 2

20 parts by weight of the IR absorption particles Cs_{0.33}WO_{2.97}Cl_{0.03} prepared by Preparation Example 3 and 2 parts by weight of diblock copolymer DBDP05 prepared by Preparation Example 1 were added into 78 parts by weight of water, and continuously stirred at room temperature for 1 hour. Subsequently, 350 g of zirconium balls (diameter of 0.2 mm) were added into the dispersion to further disperse by ball-milling (2700 rpm) at 20° C. for 3 hours. The zirconium balls were then removed by filtering, and the dispersion was sampled to measure the diameter of the IR absorption particles thereof, as shown in Table 1.

### Example 3

18.2 parts by weight of the IR absorption particles Cs_{0.33}WO_{2.97}Cl_{0.03} prepared by Preparation Example 3 and 1.82 parts by weight of diblock copolymer DBDP06 prepared by Preparation Example 2 were added into 79.98 parts by weight of water, and continuously stirred at room temperature for 1 hour. Subsequently, 350 g of zirconium balls (diameter of 0.2 mm) were added into the dispersion to further disperse by ball-milling (2700 rpm) at 20° C. for 3 hours. The zirconium balls were then removed by filtering, and the dispersion was sampled to measure the diameter of the IR absorption particles thereof, as shown in Table 1.

### Example 4

16.0 parts by weight of the IR absorption particles Cs_{0.33}WO₃ prepared by Preparation Example 4 and 1.2 parts by weight of diblock copolymer DBDP06 prepared by Preparation Example 2 were added into 82.8 parts by weight of water, and continuously stirred at room temperature for 1 hour. Subsequently, 350 g of zirconium balls (diameter of 0.2 mm) were added into the dispersion to further disperse by ball-milling (2700 rpm) at 20° C. for 3 hours. The zirconium balls were then removed by filtering, and the dispersion was sampled to measure the diameter of the IR absorption particles thereof, as shown in Table 1.

### Comparative Example 4

Aqueous dispersion of tungsten oxide particles (commercially available from Wenxuan Industrial Co., Ltd) served as a dispersion of IR absorption particles, and the IR absorption particles content in the dispersion was 20 wt %.

### Comparative Example 5

Dispersion of antimony tin oxide (ATO, SnO₂:Sb, commercially available from Just Nanotech Co., Ltd) served as a dispersion of IR absorption particles, and the IR absorption particles content in the dispersion was 20 wt %.

TABLE 1

| | | IR | | | | | |
|---|---|---|---|---|---|---|---|
| | | absorption | | Dispersant/ | | | |
| | | particles | | IR absorption | | | |
| | IR absorption | content | | particles | Dₐᵥₑ | D₉₅ | D₁₀₀ |
| Example | particles | (wt %) | Dispersant | (weight ratio) | (nm) | (nm) | (nm) |
| Comparative | Cs_{0.33}WO_{2.97}Cl_{0.03} | 26.7 | BYK190 | 0.10 | 80 | 172 | 396 |
| Example 1 | | | | | | | |
| Comparative | Cs_{0.33}WO_{2.97}Cl_{0.03} | 12.0 | BYK190 | 0.10 | 78 | 166 | 342 |
| Example 2 | | | | | | | |
| Comparative | Cs_{0.33}WO_{2.97}Cl_{0.03} | 17.4 | BYK190 | 0.10 | 80 | 161 | 295 |
| Example 3 | | | | | | | |
| Example 1 | Cs_{0.33}WO_{2.97}Cl_{0.03} | 20.0 | DBDP05 | 0.10 | 30 | 61 | 106 |
| Example 2 | Cs_{0.33}WO_{2.97}Cl_{0.03} | 20.0 | DBDP05 | 0.10 | 50 | 103 | 190 |
| Example 3 | Cs_{0.33}WO_{2.97}Cl_{0.03} | 18.2 | DBDP06 | 0.1 | 13 | 100 | 190 |
| Example 4 | Cs_{0.33}WO₃ | 16.0 | DBDP06 | 0.075 | 38 | 123 | 255 |
| Comparative | WO₃ | 20.0 | Unknown | Unknown | 80 | Unknown | Unknown |
| Example 4 | | | | | | | |
| Comparative | ATO | 20.0 | Unknown | Unknown | 95 | 186 | 342 |
| Example 5 | | | | | | | |

As shown in Table 1, the IR absorption particles in the dispersion utilizing the diblock copolymer as dispersant had a diameter less than that of the IR absorption particles in the dispersion utilizing the commercially available dispersant (or the commercially available dispersion with unknown dispersant). Accordingly, the diblock copolymer is excellent for use in dispersing the IR absorption particles.

### Example 5-1 (Inkjet Ink IR022A)

66.3 g of water and 5.4 g of diethylene glycol (DEG) serving as polar solvent, 0.1 g of BYK192 (aqueous copolymer, commercially available from BYK) and 0.1 g of BYK333 (polyether modified polydimethylsiloxane, commercially available from BYK) serving as additive, and 28.1 g of the dispersion of the IR absorption particles prepared by Comparative Example 1 were mixed and then continuously stirred at room temperature for 1 hour to obtain an inkjet ink. The contents of each composition, content of the IR absorption particles, viscosity (measured by a viscometer DV2TLVCJ0 commercially available from Brookfield), and surface tension (measured by standard ASTM D971) of the inkjet ink are shown in Table 2.

### Example 5-2 (Inkjet Ink IR025)

6.2 g of DEG serving as polar solvent, 0.3 g of BYK192 and 0.3 g of BYK333 serving as additive, and 93.2 g of the dispersion of the IR absorption particles prepared by Comparative Example 2 were mixed and then continuously stirred at room temperature for 1 hour to obtain an inkjet ink. The contents of each composition, content of the IR absorption particles, viscosity, and surface tension of the inkjet ink are shown in Table 2.

### Example 5-3 (Inkjet Ink IR036)

31.0 g of water and 9.6 g of DEG serving as polar solvent, 0.3 g of BYK192 and 0.3 g of BYK333 serving as additive, and 58.8 g of the dispersion of the IR absorption particles prepared by Comparative Example 3 were mixed and then continuously stirred at room temperature for 1 hour to obtain an inkjet ink. The contents of each composition, content of the IR absorption particles, viscosity, and surface tension of the inkjet ink are shown in Table 2.

### Example 5-4 (Inkjet Ink IR038)

28.7 g of water and 10.7 g of DEG serving as polar solvent, 0.3 g of BYK192 and 0.3 g of BYK333 serving as additive, and 60.0 g of the dispersion of the IR absorption particles prepared by Example 1 were mixed and then continuously stirred at room temperature for 1 hour to obtain an inkjet ink. The contents of each composition, content of the IR absorption particles, viscosity, and surface tension of the inkjet ink are shown in Table 2.

### Example 5-5 (Inkjet Ink IR039)

14.1 g of water and 10.3 g of DEG serving as polar solvent, 0.3 g of BYK192 and 0.3 g of BYK333 serving as additive, and 75.0 g of the dispersion of the IR absorption particles prepared by Example 1 were mixed and then continuously stirred at room temperature for 1 hour to obtain an inkjet ink. The contents of each composition, content of the IR absorption particles, viscosity, and surface tension of the inkjet ink are shown in Table 2.

### Example 5-6 (Inkjet Ink IR040)

9.4 g of DEG serving as polar solvent, 0.3 g of BYK192 and 0.3 g of BYK333 serving as additive, and 90.0 g of the dispersion of the IR absorption particles prepared by Example 1 were mixed and then continuously stirred at room temperature for 1 hour to obtain an inkjet ink. The contents of each composition, content of the IR absorption particles, viscosity, and surface tension of the inkjet ink are shown in Table 2.

### Example 5-7 (Inkjet Ink IR041)

28.7 g of water and 10.7 g of DEG serving as polar solvent, 0.3 g of BYK192 and 0.3 g of BYK333 serving as additive, and 60.0 g of the dispersion of the IR absorption particles prepared by Example 2 were mixed and then continuously stirred at room temperature for 1 hour to obtain an inkjet ink. The contents of each composition, content of the IR absorption particles, viscosity, and surface tension of the inkjet ink are shown in Table 2.

### Example 5-8 (Inkjet Ink IR042)

14.1 g of water and 10.3 g of DEG serving as polar solvent, 0.3 g of BYK192 and 0.3 g of BYK333 serving as additive, and 75.0 g of the dispersion of the IR absorption particles prepared by Example 2 were mixed and then continuously stirred at room temperature for 1 hour to obtain an inkjet ink. The contents of each composition, content of the IR absorption particles, viscosity, and surface tension of the inkjet ink are shown in Table 2.

### Example 5-9 (Inkjet Ink IR043)

9.4 g of DEG serving as polar solvent, 0.3 g of BYK192 and 0.3 g of BYK333 serving as additive, and 90.0 g of the dispersion of the IR absorption particles prepared by Example 2 were mixed and then continuously stirred at room temperature for 1 hour to obtain an inkjet ink. The contents of each composition, content of the IR absorption particles, viscosity, and surface tension of the inkjet ink are shown in Table 2.

### Example 5-10 (Inkjet Ink IR045)

10.0 g of DEG serving as polar solvent, 0.3 g of BYK192 and 0.3 g of BYK333 serving as additive, and 89.4 g of the dispersion of the IR absorption particles prepared by Example 3 were mixed and then continuously stirred at room temperature for 1 hour to obtain an inkjet ink. The contents of each composition, content of the IR absorption particles, viscosity, and surface tension of the inkjet ink are shown in Table 2.

### Example 5-11 (Inkjet Ink IR051)

12.7 g of DEG serving as polar solvent, 0.3 g of BYK192 and 0.3 g of BYK333 serving as additive, and 86.7 g of the dispersion of the IR absorption particles prepared by Comparative Example 5 were mixed and then continuously stirred at room temperature for 1 hour to obtain an inkjet ink. The contents of each composition, content of the IR absorption particles, viscosity, and surface tension of the inkjet ink are shown in Table 2.

### Example 5-12 (Inkjet Ink IRA)

13.0 g of water and 11.3 g of DEG serving as polar solvent, 0.3 g of BYK192 and 0.3 g of BYK333 serving as additive, and 75.1 g of the dispersion of the IR absorption particles prepared by Comparative Example 4 were mixed and then continuously stirred at room temperature for 1 hour to obtain an inkjet ink. The contents of each composition, content of the IR absorption particles, viscosity, and surface tension of the inkjet ink are shown in Table 2.

TABLE 2

| | | | | | Dispersion | | | |
|---|---|---|---|---|---|---|---|---|
| | | | | | of IR | | | |
| | | | | | absorption | Particles | | Surface |
| | H₂O | DEG | BYK192 | BYK333 | particles | content | Viscosity | tension |
| Ink No. | (g) | (g) | (g) | (g) | (g) | (wt %) | (cps) | (mN/m) |
| IR022A | 66.3 | 5.4 | 0.1 | 0.1 | Comparative | 7.5 | 2.5 | 36 |
| | | | | | Example 1 (28.1) | | | |
| IR025 | 0 | 6.2 | 0.3 | 0.3 | Comparative | 11.2 | 2.1 | 37 |
| | | | | | Example 2 (93.2) | | | |
| IR036 | 31.0 | 9.6 | 0.3 | 0.3 | Comparative | 10.3 | 3.1 | 37 |
| | | | | | Example 3 (58.8) | | | |
| IR038 | 28.7 | 10.7 | 0.3 | 0.3 | Example 1 (60.0) | 12.0 | 2.3 | 37 |
| IR039 | 14.1 | 10.3 | 0.3 | 0.3 | Example 1 (75.0) | 15.0 | 2.6 | 37 |
| IR040 | 0 | 9.4 | 0.3 | 0.3 | Example 1 (90.0) | 18.0 | 3.0 | 37 |
| IR041 | 28.7 | 10.7 | 0.3 | 0.3 | Example 2 (60.0) | 12.0 | 2.5 | 37 |
| IR042 | 14.1 | 10.3 | 0.3 | 0.3 | Example 2 (75.0) | 15.0 | 2.8 | 37 |
| IR043 | 0 | 9.4 | 0.3 | 0.3 | Example 2 (90.0) | 18.0 | 3.0 | 37 |
| IR045 | 0 | 10.0 | 0.3 | 0.3 | Example 3 (89.4) | 15.6 | 3.0 | 36 |
| IR051 | 0 | 12.7 | 0.3 | 0.3 | Comparative | 17.3 | 5.3 | 22 |
| | | | | | Example 5 (86.7) | | | |
| IR061 | 10.5 | 6.5 | 0.3 | 0.3 | Example 4 (80.7) | 12.9 | 2.9 | 36 |
| IRA | 13.0 | 11.3 | 0.3 | 0.3 | Comparative | 15.0 | 3.0 | 36 |
| | | | | | Example 4 (75.1) | | | |

### Example 6-1 (Yellow Ink IRY31)

6.00 g of the yellow pigment (Paliotol® Yellow D 1080 J, commercially available from BASF) and 1.50 g of the diblock copolymer prepared by Preparation Example 2 were added into 22.50 g of water, and then continuous stirred at room temperature for 1 hour. Subsequently, 75 g of zirconium balls (diameter of 0.2 mm) were added into the above dispersion to perform ball-milling to obtain a yellow pigment dispersion.

95 g of inkjet ink IR045 prepared by Example 5-10 and 5 g of the yellow pigment dispersion were mixed, and continuously stirred at room temperature for 1 hour to obtain a yellow inkjet ink IRY31. The composition content and the color space coordinates of the yellow inkjet ink IRY31 are shown in Table 3.

### Example 6-2 (Red Ink IRR24)

6.00 g of the red pigment (Irgazin® Red L 3630, commercially available from BASF) and 1.80 g of the diblock copolymer prepared by Preparation Example 2 were added into 19.20 g of water, and then continuous stirred at room temperature for 1 hour. Subsequently, 120 g of zirconium balls (diameter of 0.2 mm) were added into the above dispersion to perform ball-milling to obtain a red pigment dispersion.

95 g of inkjet ink IR045 prepared by Example 5-10 and 5 g of the red pigment dispersion were mixed, and continuously stirred at room temperature for 1 hour to obtain a red inkjet ink IRR24. The composition content and the color space coordinates of the red inkjet ink IRR24 are shown in Table 3.

### Example 6-3 (Blue Ink IRB20)

7.50 g of the blue pigment (HELIOGEN BLUE L 6700 F, commercially available from BASF) and 1.50 g of the diblock copolymer prepared by Preparation Example 2 were added into 18.00 g of water, and then continuous stirred at room temperature for 1 hour. Subsequently, 100 g of zirconium balls (diameter of 0.2 mm) were added into the above dispersion to perform ball-milling to obtain a blue pigment dispersion.

95 g of inkjet ink IR045 prepared by Example 5-10 and 5 g of the blue pigment dispersion were mixed, and continuously stirred at room temperature for 1 hour to obtain a blue inkjet ink IRB20. The composition content and the color space coordinates of the blue inkjet ink IRB20 are shown in Table 3.

TABLE 3

| | Yellow | Red | Blue | Inkjet | | | | |
|---|---|---|---|---|---|---|---|---|
| | pigment | pigment | pigment | ink | Total | | | |
| | dispersion | dispersion | dispersion | IR045 | amount | | | |
| | (g) | (g) | (g) | (g) | (g) | L* | a* | b* |
| IRY31 | 5 | 0 | 0 | 95 | 100 | 71.4 | −4.7 | 72.5 |
| IRR24 | 0 | 5 | 0 | 95 | 100 | 58.5 | 23.6 | −8.0 |
| IRB20 | 0 | 0 | 5 | 95 | 100 | 56.0 | −16.4 | −28.2 |

### Example 6-4 (Blue Inkjet Ink IR061)

7.50 g of the blue pigment (HELIOGEN BLUE L 6700 F, commercially available from BASF) and 1.50 g of the diblock copolymer prepared by Preparation Example 2 were added into 18.00 g of water, and then continuous stirred at room temperature for 1 hour. Subsequently, 100 g of zirconium balls (diameter of 0.2 mm) were added into the above dispersion to perform ball-milling to obtain a blue pigment dispersion. 80.7 g of the dispersion of IR absorption particles prepared by Preparation Example 4, 1.7 g of the blue pigment dispersion, 10.5 g of water and 6.5 g of DEG serving as polar solvent, 0.3 g of BYK192 and 0.3 g of BYK333 serving as additive were mixed, and continuously stirred at room temperature for 1 hour, thereby obtaining blue inkjet ink IR061.

### Example 7-1

In a 3D printer ComeTrue T10 (commercially available from MicroJet Technology Co., Ltd.), polyamide PA-12 powder with a diameter of 10 μm to 100 μm (commercially available from EOS) was paved as a layer with a thickness of about 0.18 mm. Subsequently, the inkjet ink IR045 prepared by Example 5-10 was inkjetted to the PA-12 powder layer. The PA-12 powder layer was then exposed to IR with a wavelength of 760 nm to 3500 nm and a power of 900 W for about 6 seconds, such that the IR absorption particles of the inkjet ink in the inkjet pattern absorbs the IR to increase the temperature for fusing the PA-12 powder around the inkjet ink. In the IR heating, fusing, and shaping process, the inkjet pattern (containing the inkjet ink and the PA-12 powder) had a temperature difference of 68.5° C. before and after the IR exposure.

### Example 7-2

In the 3D printer ComeTrue T10 (commercially available from MicroJet Technology Co., Ltd.), polyamide PA-12 powder was paved as a layer with a thickness of about 180 μm. The PA-12 powder layer was then exposed to IR with a wavelength of 760 nm to 3500 nm and a power of 900 W for about 6 seconds, thereby fusing the PA-12 powder. In the IR heating, fusing, and shaping process, the PA-12 powder had a temperature difference of 40.8° C. before and after the IR exposure.

### Example 7-3

In the 3D printer ComeTrue T10 (commercially available from MicroJet Technology Co., Ltd.), polyamide PA-12 powder was paved as a layer with a thickness of about 180 μm. Subsequently, water was inkjetted to the PA-12 powder layer. The PA-12 powder layer was then exposed to IR with a wavelength of 760 nm to 3500 nm and a power of 900 W for about 6 seconds, thereby fusing the PA-12 powder. In the IR heating, fusing, and shaping process, the inkjet pattern (containing water and the PA-12 powder) had a temperature difference of 30.5° C. before and after the IR exposure.

### Example 7-4

In the 3D printer ComeTrue T10 (commercially available from MicroJet Technology Co., Ltd.), polyamide PA-12 powder was paved as a layer with a thickness of about 180 μm. Subsequently, the IR absorption inkjet ink HP727 (commercially available from Hewlett-Packard Company) was inkjetted to the PA-12 powder layer. The PA-12 powder layer was then exposed to IR with a wavelength of 760 nm to 3500 nm and a power of 900 W for about 6 seconds, thereby fusing the PA-12 powder. In the IR heating, fusing, and shaping process, the inkjet pattern (containing the inkjet ink HP727 and the PA-12 powder) had a temperature difference of 56.5° C. before and after the IR exposure. In addition, most of the IR absorption particles of the inkjet ink HP727 were carbon black, such that the product was almost opaque.

### Example 8 (3D Printing)

In the 3D printer ComeTrue T10 (commercially available from MicroJet Technology Co., Ltd.), self-made thermoplastic urethane (TPU) powder with a diameter of 10 μm to 300 μm was paved as a layer with a thickness of about 180 μm. Subsequently, the inkjet ink IR061 prepared by Example 6-4 was inkjetted to the TPU powder layer, and the inkjet pattern corresponded to the sample size of the testing standard ASTM D412 Type C. The TPU powder layer was then exposed to IR with a wavelength of 1500 nm to 1600 nm and a power of 1000 W for about 6 seconds, thereby fusing the TPU powder around the inkjet ink. The TPU powder out of the inkjet pattern was removed after the IR fusing process, thereby obtaining a sample. The sample had a tensile strength of 14.7 MPa and an elongation ratio of 590%, which were measured by the testing standard ASTM D412 Type C.

### Comparative Example 6 (without any Inkjet Ink)

In the 3D printer ComeTrue T10 (commercially available from MicroJet Technology Co., Ltd.), self-made thermoplastic urethane (TPU) powder with a diameter of 10 μm to 300 μm was paved as a layer with a thickness of about 180 μm. Subsequently, the TPU powder layer was then exposed to IR with a wavelength of 1500 nm to 1600 nm and a power of 1000 W through a photomask for about 6 seconds, thereby fusing the TPU powder. The transparent part of the photomask corresponded to the sample size of the testing standard ASTM D412 Type C. The TPU powder that was not exposed to the IR was removed after the IR fusing process, thereby obtaining a sample. The sample had a tensile strength of 4.8 MPa and an elongation ratio of 305%, which were measured by the testing standard ASTM D412 Type C. As shown in the comparison between Example 8 and Comparative Example 6, the inkjet ink was beneficial to increase the mechanical strength of the 3D printing product.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A dispersion of IR absorption particles, comprising:
100 parts by weight of IR absorption particles;
5 to 30 parts by weight of diblock copolymer; and
200 to 910 parts by weight of water,
wherein the diblock copolymer includes (a) first block of 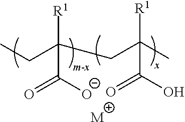
and (b) second block of 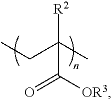
wherein (a) first block is chemically bonded to (b) second block,
R¹ is H or CH₃;
R² is H or CH₃;
R³ is 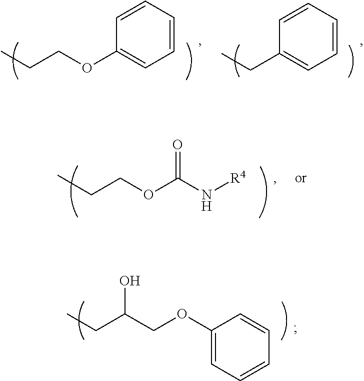
R⁴ is C₁₋₁₀ alkyl group;
M^{⊕} is Na⁺, NH₄⁺, or NH(C₂H₄OH)₃⁺;
m=10-20;
n=2-20; and
x=0-4.

2. The dispersion as claimed in claim 1, wherein the IR absorption particles comprise antimony tin oxide, tungsten oxide, MₐWO_{3-b}A_{b}, MₐWO_{3-b}, or a combination thereof, wherein M is alkali metal element, A is halogen element, 0<a≤1, and 0≤b≤0.8.

3. The dispersion as claimed in claim 1, wherein the IR absorption particles have a diameter of 10 nm to 500 nm.

4. The dispersion as claimed in claim 1, wherein m and n have a ratio of 7:1 to 1:2.

5. The dispersion as claimed in claim 1, wherein the diblock copolymer has a poly dispersity index of less than 1.8 and greater than 1.

6. An inkjet ink, comprising:
a dispersion of IR absorption particles;
30 to 1000 parts by weight of polar solvent; and
1 to 10 parts by weight of additive,
wherein the dispersion of IR absorption particles includes:
100 parts by weight of IR absorption particles;
5 to 30 parts by weight of diblock copolymer; and
200 to 910 parts by weight of water,
wherein the diblock copolymer includes (a) first block of 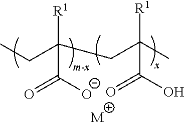
and (b) second block of 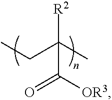
wherein (a) first block is chemically bonded to (b) second block,
R¹ is H or CH₃;
R² is H or CH₃;
R³ is 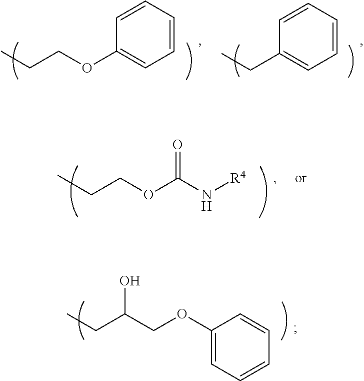
R⁴ is C₁₋₁₀ alkyl group;
M^{⊕} is Na⁺, NH₄⁺, or NH(C₂H₄OH)₃⁺;
m=10-20;
n=2-20; and
x=0-4.

7. The inkjet ink as claimed in claim 6, wherein the polar solvent comprises water, N-methyl-2-pyrrolidone, 2-pyrrolidone, diethylene glycol, glycerin, hexylene glycol and propylene glycol, butylene glycol, pentylene glycol, hexylene glycol, polyethylene glycol, ethylene glycol monobutyl ether, or a combination thereof.

8. The inkjet ink as claimed in claim 6, wherein the additive comprises aqueous copolymer, polyether modified polydimethylsiloxane, or a combination thereof.

9. The inkjet ink as claimed in claim 6, further comprising a pigment dispersion, and the pigment dispersion includes:
2 to 10 parts by weight of water;
0.1 to 2.0 parts by weight of pigment; and
0.1 to 0.6 parts by weight of dispersant.

10. A method of 3D printing, comprising:
providing a layer, wherein the layer includes polymer powders;
applying an inkjet ink to the layer for forming a pattern;
applying IR to the layer for fusing and shaping the pattern; and
removing the polymer powders which are out of the pattern,
wherein the inkjet ink includes:
a dispersion of IR absorption particles;
30 to 1000 parts by weight of polar solvent; and
1 to 10 parts by weight of additive,
wherein the dispersion of IR absorption particles includes:
100 parts by weight of IR absorption particles;
5 to 30 parts by weight of diblock copolymer; and
200 to 910 parts by weight of water,
wherein the diblock copolymer includes (a) first block of 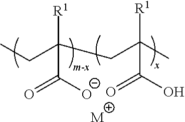
and (b) second block of 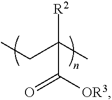
wherein (a) first block is chemically bonded to (b) second block,
R¹ is H or CH₃;
R² is H or CH₃;
R³ is 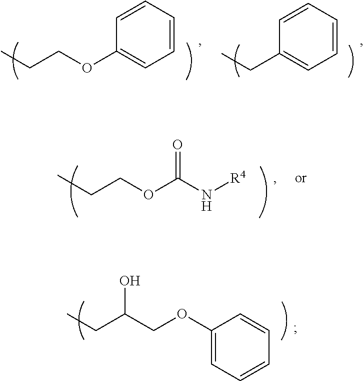
R⁴ is C₁₋₁₀ alkyl group;
M^{⊕} is Na⁺, NH₄⁺, or NH(C₂H₄OH)₃⁺;
m=10-20;
n=2-20; and
x=0-4.
